(19) United States
(12) Patent Application Publication
(10) Pub. No.: US 2002/0062299 A1
(43) Pub. Date: May 23, 2002

(54) Product information notification method and product information notification system

(76) Inventors: Ryuichi Matsukura, Kawasaki (JP); Tatsuro Matsumoto, Kawasaki (JP); Ai Yano, Kawasaki (JP); Kazuo Sasaki, Kawasaki (JP)

Correspondence Address: STAAS & HALSEY LLP, 700 11TH STREET, NW, SUITE 500, WASHINGTON, DC, 20001, US

(21) Appl. No.: 09/809,110

(22) Filed: Mar. 16, 2001

(30) Foreign Application Priority Data
Nov. 22, 2000 (JP) 2000-355269

(51) Int. Cl. G06F 7/00

(52) U.S. Cl. 707/1

(57) ABSTRACT

Product information notification method and product information notification system wherein additional information for a product can be modified for each user, allowing for an effective sales presentation. From a product information database 1 storing basic information for each product, basic information for a product group that a user wishes to look up is selected and presented to the user using product information presentation means 2; based on user profile information obtained by profile information acquisition means 4, a display parameters processing unit 5 selects from an additional information database 3 corresponding additional information and presents this to the user using additional information presentation means 6.

### BACKGROUND OF THE INVENTION

1. Technical Field

The present invention provides a product information notification method and product information notification system that make possible an effective presentation to users wishing to look up product information.

2. Description of Related Art

In product sales at stores, when products on display are changed when the seasons change and when new products arrive in stock, it is customary to place tags on the shelves where the products are displayed, in order to catch the eyes of customers.

In online shopping, too, where product sales are carried out over the Internet, tags that display such information as new products and discount rates are provided on a list screen displaying a list of products.

When tags are attached to products displayed in stores, and when tags are attached to products displayed in online shopping, additional information regarding that product can be displayed; however, the same information is always displayed, regardless of the type of user wishing to look up that profile information.

If it were possible for the additional profile information displayed on these types of tags to change based on profile information of users wishing to look up that product information, it would be possible to present information that each user needs, and by using this information a user would have no misconceptions about the product, and would be able to make purchases under favorable conditions. The party selling the product would be able to make an effective presentation based upon the profile information of each individual user, and this would be expected to lead to an increase in sales.

### SUMMARY OF THE INVENTION

It is an object of the present invention to present a product information notification method and product information notification system that makes it possible to change additional product information for each user and conduct effective presentations.

The product information notification method of the present invention acquires user profile information of a user wishing to look up basic information for an individual product; selects basic information of a product group that a user wishes to look up from a product information database that stores basic information for each product and presents this to the user; and selects additional information corresponding to user profile information regarding the product group from an additional informational database that stores additional information for individual products, and presents this to the user.

The product information notification system of a second aspect of the present invention comprises profile information acquisition means for acquiring profile information of a user wishing to look up basic information for an individual product; a product information database storing basic information for individual products; product information presentation means for presenting from the product information database basic information of a product group that the user wishes to look up; an additional information database storing additional information for individual products; display parameters processing means for selecting corresponding additional information from the additional information database based on profile information acquired by the profile information acquisition means; and additional information presentation means for presenting to the user additional information selected by the display parameters processing means.

A third aspect of the present invention provides the product information notification system according to the second aspect, wherein the profile information acquisition means conducts wireless communication with a user terminal storing that user's profile information to acquire the user's profile information.

A fourth aspect of the present invention provides the product information notification system according to the second aspect, wherein the profile information acquisition means conducts wireless communication with a user terminal storing that user's identification information, and acquires from a profile database storing user profile information user profile information corresponding to the user identification information.

A fifth aspect of the present invention provides a product information notification system according to any of the second through fourth aspects, wherein the product information presentation means and additional information presentation means include, respectively, product information presentation means and additional information presentation means provided in the vicinity of the individual product.

A sixth aspect of the present invention provides a product information notification system according to either the third aspect or the fourth aspect, wherein the product information presentation means and additional information presentation means respectively include product information transmission means transmitting information to be displayed by product information display means and additional information display means provided on the user terminal.

The product information notification system of a seventh aspect of the present invention according to the second aspect may be configured to have a product information management server that manages the product information database and comprises a WWW server that presents information to a user terminal having a WWW browser, the WWW server comprising the product information presentation means and additional information presentation means.

An eighth aspect of the present invention provides the product information notification system according to the seventh aspect, wherein the profile information acquisition means acquires a user's profile information from the user's terminal over the Internet.

A ninth aspect of the present invention provides the product information notification system according to the seventh aspect, wherein the profile information acquisition means acquires a user's identification information from the user's terminal over the Internet, and acquires from a profile database storing user profile information profile information corresponding to the user's identification information.

A tenth aspect of the present invention provides the product information notification system according to the ninth aspect, wherein the product information management server manages the profile database.

An eleventh aspect of the present invention provides the product information notification system according to the ninth aspect, wherein a customer management server interconnected with the product information server manages the profile database.

A twelfth aspect of the present invention provides a product information notification system according to any of the seventh through eleventh aspects, wherein the product information server manages the additional information database and includes the display parameters processing means.

In addition, the product information notification system of a thirteenth aspect of the present invention according to the seventh through eleventh aspects may be configured so that an additional information management server interconnected with the product management server manages the additional information database and includes display parameters processing means.

Further, the product information notification system of a fourteenth aspect of the present invention according to the seventh through thirteenth aspects may be configured so that product information presentation means and additional information presentation means include a terminal linkage unit that operates on a WWW browser on a user terminal.

A fifteenth aspect of the present invention provides the product information notification system according to the fourteenth aspect, wherein the terminal linkage unit is a Java applet for displaying additional information.

A sixteenth aspect of the present invention provides the product information notification system according to the fourteenth aspect, wherein the terminal linkage unit is a Java applet for comment input accepting input of comments from the user terminal.

A seventeenth aspect of the present invention provides the product information notification system according to the sixteenth aspect, further comprising a comment database managing comments from the user terminal accepted by the terminal linkage unit.

An eighteenth aspect of the present invention provides the product information notification system according to the fourteenth aspect, wherein the terminal linkage unit is a chat linkage unit accepting chat by the user terminal.

A nineteenth aspect of the present invention provides the product information notification system according to the eighteenth aspect, further comprising a chat channel management unit managing chat contents accepted by the chat linkage unit.

A twentieth aspect of the present invention provides the product information notification system according to the fourteenth aspect, wherein the terminal linkage unit is an order acceptance linkage unit accepting product orders from the user terminal.

A twenty-first aspect of the present invention provides the product information notification system according to the twentieth aspect, further comprising an order procedure unit conducting order procedures based on a product order accepted by the order acceptance unit.

A twenty-second aspect of the present invention provides a computer readable recording medium on which is recorded a program for a product information notification method wherein:

profile information of a user wishing to look up basic information for an individual product is acquired;

basic information of a product group that the user wishes to look up is selected from a product information database storing basic information of the individual product and presented to the user; and

additional information regarding products in the product group that corresponds to the user profile information is selected from a database storing additional information for the individual product and presented to the user.

From the following detailed description in conjunction with the accompanying drawings, the foregoing and other objects, features, aspects and advantages of the present invention will become readily apparent to those skilled in the art.

### BRIEF DESCRIPTION OF THE DRAWINGS

FIG. 1 is a block diagram showing a summary of the configuration of the present invention;

FIG. 2 is a control block diagram of the first embodiment;

FIG. 3 is a diagram showing an example of the product information display means;

FIG. 4 is a diagram for explaining an additional information database table;

FIG. 5 is a diagram for explaining a profile information table;

FIG. 6 is a control block diagram of the second embodiment;

FIG. 7 is a control block diagram of the third embodiment;

FIG. 8 is a diagram for explaining a product information screen in the third embodiment;

FIG. 9 is a control block diagram of the fourth embodiment;

FIG. 10 is a control block diagram of the fifth embodiment;

FIG. 11 is a control block diagram of the sixth embodiment;

FIG. 12 is a control block diagram of the seventh embodiment;

FIG. 13 is a diagram for explaining a product information screen in the seventh embodiment;

FIG. 14 is a control block diagram of the eighth embodiment;

FIG. 15 is a diagram for explaining a product information screen in the eighth embodiment;

FIG. 16 is a diagram for explaining a product information screen in the eighth embodiment;

FIG. 17 is a control block diagram of the ninth embodiment;

FIG. 18 is a diagram for explaining a product information screen in the ninth embodiment;

FIG. 19 is a control block diagram of the tenth embodiment;

FIG. 20 is a diagram for explaining the chat window in the tenth embodiment; and

FIG. 21 is a control block diagram of the eleventh embodiment.

### DETAILED DESCRIPTION OF THE PREFERRED EMBODIMENTS

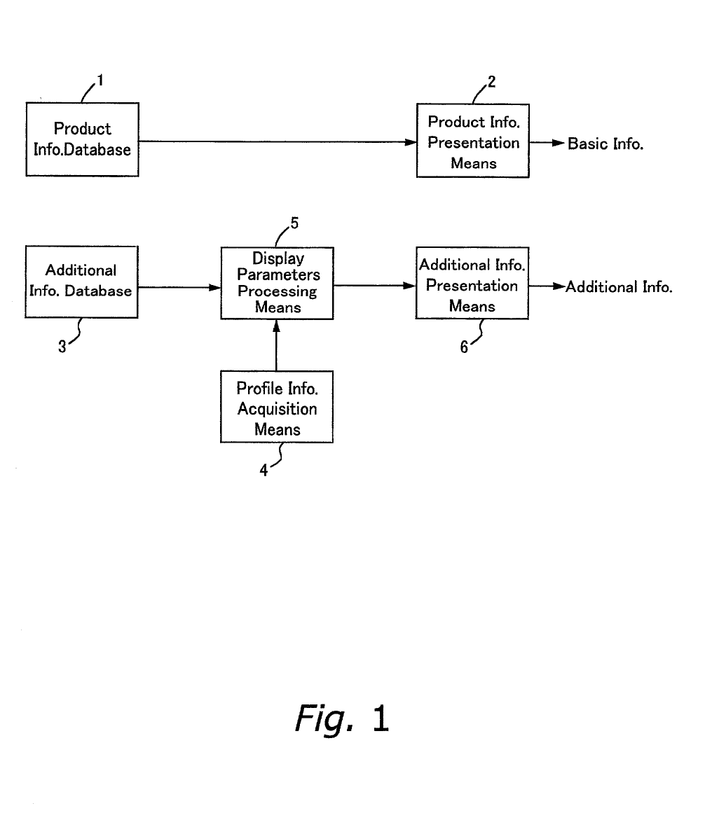

The configuration of the present invention will be summarized based on FIG. 1.

A product information database 1 stores basic information for individual products, including product name, sizes, colors, name of manufacturer and the like. Product information presentation means 2 presents basic information for a product group that a user wishes to look up from the basic information for individual products stored in the product information database 1.

An additional information database 3 stores additional information for individual products classified according to user profile; for example, this stores information to the effect that a product is new, information to the effect that a product is recommended for certain users, information to the effect that stock for a certain product is low, discount rates, methods for displaying such information, and the like.

Profile information acquisition means 4 acquires user profile information, and is configured so as to acquire from a profile database (not shown in figure) profile information of a user wishing to look up product information.

Display parameters processing means 5 acquires additional information in the additional information database 3 based on user profile information acquired by profile information acquisition means 4.

Additional information presentation means 6 presents to the user additional information selected by display parameters processing means 5.

Profile information acquisition means 4 acquires from a user terminal storing profile information or from the profile database profile information of a user wishing to look up product information. Product basic information that a user wishes to look up is selected as needed from the product information database 1 and is presented to the user by product information presentation means 2. Display parameters processing means 5 selects additional information in the additional information database 3 based on user profile information acquired by profile information acquisition means 4, and presents additional information to the user via additional information presentation means 6.

Product information presentation means 2 and additional information presentation means 6 may be constituted by display means placed near products in a store where products are on display. They may also be configured to display product basic information and additional information using display means provided on a user terminal that a user carries.

The present invention may be so configured as to comprise a web site for online shopping over the Internet, and configured so that data is transmitted to and received from a user terminal over the Internet, presenting basic information and additional information for products. In such a case, it may be configured so that a WWW web server is loaded onto a product information management server that manages a product information database, and various types of information are presented to a WWW browser loaded onto a user terminal.

Further, the present invention may be configured so that profile information is managed at user terminals, and profile information is transmitted each time a user accesses the product information management server. Other conceivable configurations include having the product information management server manager profile information and having a client management server other than the product information management server manage profile information.

Also conceivable are configurations such that the additional information database is managed by a product information management server, or that the additional information database is managed by an additional information management server other than the product information management server.

Various embodiments of this nature will be discussed in detail below.

First Embodiment

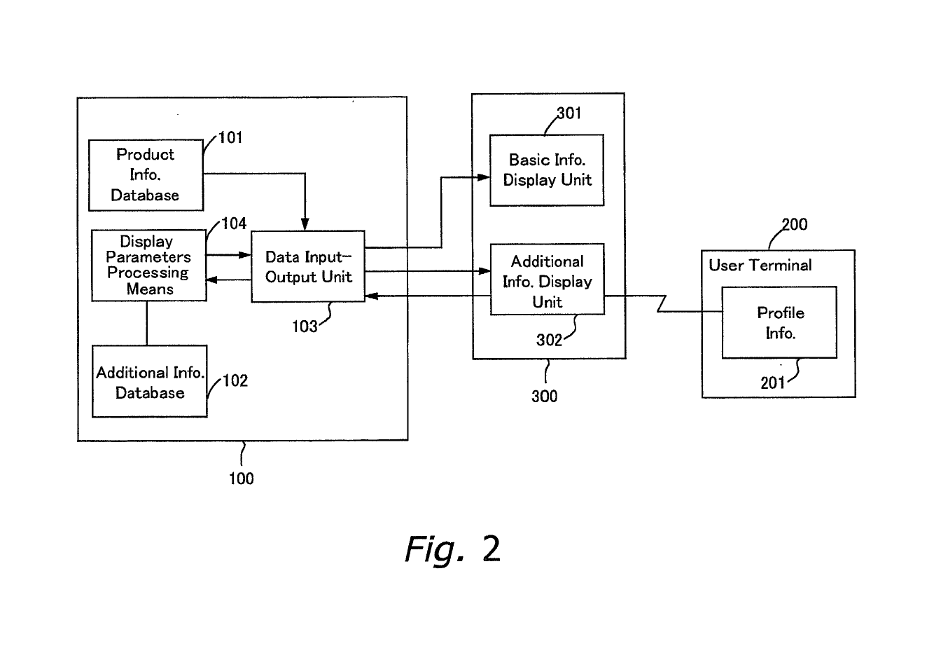

FIG. 2 shows a first embodiment of the present invention, wherein the product information notification system of the present invention has been adopted for use in a store where the actual products themselves are on display.

The product information notification system within a store comprises a product information management server 100 for managing a variety of product information and a product information display unit 300, which is interconnected with the product information management server 100 and displays a variety of product information that is transmitted from the product information management server 100. The product information display unit 300 comprises wireless telecommunication means (not shown in figure), and is capable of receiving profile information from a user terminal 200 carried by a user.

The product information management server 100 manages a product information database 101 and an additional information database 102. The product information database 101, as described above, stores basic information for individual products, including product name, sizes, colors, manufacturer's name, and the like. The basic information within this product information database 101 is transmitted to the product information display unit 300 via a data input-output unit 103.

The additional information database 102 stores additional information corresponding to user profile information; for example, it may be configured to comprise display information that will vary depending upon such factors as user sex, age, occupation and the like.

The product information management server 100 comprises display parameters processing means 104. This display parameters processing means 104 receives user profile information from the data input-output unit 103, selects additional information corresponding to that profile information from the additional information stored in the additional information database 102, and transmits this to the data input-output unit 103.

The data input-output unit 103 transmits product basic information stored in the product information database 101 to the product information display unit 300, causing the basic information display unit 301 to display the same. The data input-output unit 103 also receives user profile information from the product information display unit 300 and transmits this to the display parameters processing means 104; it also receives from the display parameters processing means 104 additional information corresponding to the user profile information, transmits this additional information to the product information display unit 300, and causes the additional information display unit 302 to display the same.

The product information display unit 300 may be a liquid crystal display device, CRT display or other display device set up near the products being displayed. The product information display unit 300 comprises the basic information display unit 301 for displaying product basic information and the additional information display unit 302 for displaying additional information; a display screen of a single display device may be divided to comprise both the basic information display unit 301 and additional information display unit 302, the basic information display unit 301 and the additional information display unit 302 may each comprise separate display devices, or a single display device may be made to comprise both the basic information display unit 301 and the additional information display unit 302 by alternating between the two.

The product information display unit 300 comprises wireless communications means, not shown in the figure, which allows it to receive profile information sent from the user terminal 200 carried by the user.

For the user terminal 200 a portable information terminal of the type known as PDAs (Personal Digital Assistants) or mobile phones may be used; the user terminal 200 comprises a profile information storage unit 201 comprising memory such as RAM backed up by EEPROM or a battery and a wireless communications unit (not shown in figure) capable of transmitting data to the product information display unit 300. Sex, age, occupation, type of household and other user profile information is input as necessary by a user into the profile information storage unit 201 of the user terminal 200 and stored therein.

It is also possible to make use of a membership card having transmission function such as a point card issued by the store to individual customers as the user terminal 200. In such a case, customer profile information may be recorded beforehand in the memory of the membership card, and by means of the transmission function this profile information is sent to the additional information display unit 302.

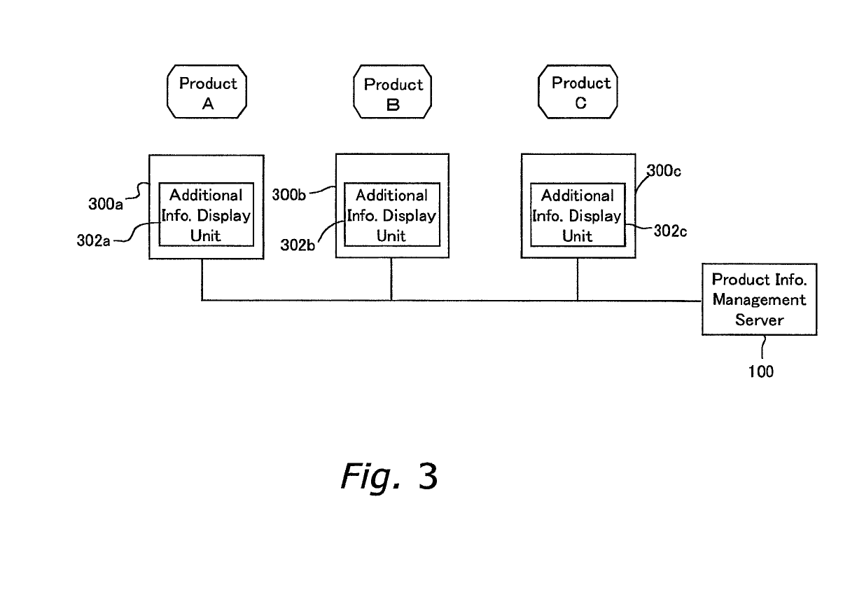

A product information display unit 300 is provided for each product on display at the store; for example, as shown in FIG. 3, product information display units 300a, 300b, and 300c are provided for product A, product B and product C, respectively. In such a case, product information display units 300a, 300b, and 300c are provided with additional information display units 302a, 302b and 302c, respectively, as well as with wireless telecommunications means. Profile information stored in the profile information storage unit 201 is transmitted from a user terminal 200 carried by a user, and the wireless transmission means of the product information display unit 300 receives this profile information when the user stands in front of a product.

The profile information received by the product information display unit 300 is sent to the display parameters processing means 104 via the data input-output unit 103 of the product information management server 100. The display parameters processing means 104 selects additional information from the additional information database 102 based on the acquired profile information, and the additional information display unit 302 of the product information display unit 300 is caused to display this additional information via the data input-output unit 103.

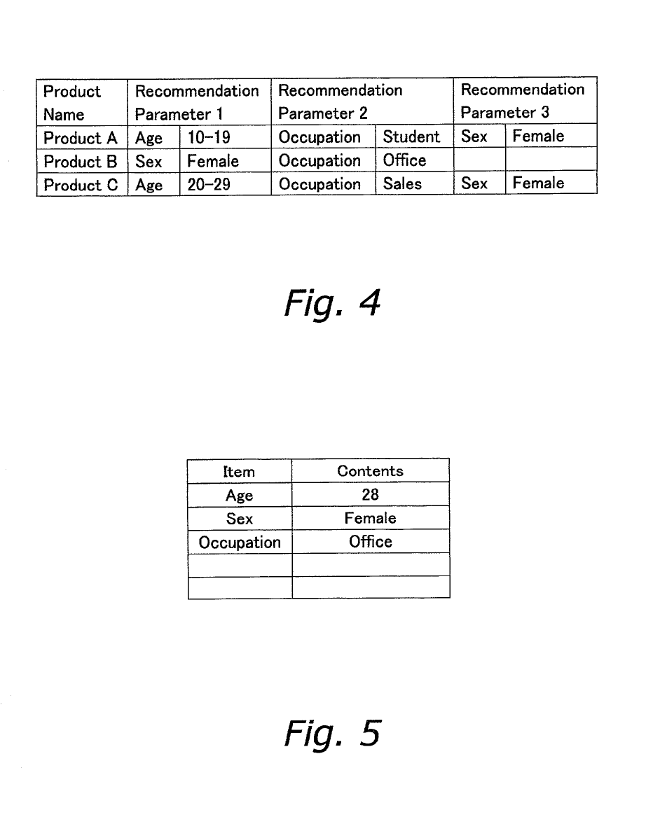

In the case of a configuration as shown in FIG. 3, the additional information stored in the additional information database 102 may be made display parameters as shown in the table of FIG. 4.

For product A, product B, and product C, recommendation parameter 1, recommendation parameter 2, and recommendation parameter 3 respectively have been set beforehand, and when the profile information of a user wishing to look up the information for a certain product matches that product's recommendation parameters, “recommended” is displayed. For example, when the profile information of a user standing in front of product A matches the parameters of age: 10 to 19, occupation: student, and sex: female, signals are sent from product information management server 100 giving instructions to display “recommended.” By so doing, the product information display unit 300a placed near product A displays the word “recommended” with its additional information display unit 302a. Similarly, for product B, when a user's profile information matches the parameters of sex: female, occupation: office worker, “recommended” is displayed, and for product C, when a user's profile matches the parameters of age: 20 to 29, occupation: sales, and sex: female, “recommended” is displayed. Here, age, sex and occupation are the parameters for determining whether to display “recommended,” and the profile information stored in the profile information storage unit 201 of the user terminal 200 may be configured to correspond thereto, as in the table shown in FIG. 5.

By employing such a configuration, additional information that corresponds to profile information of an individual user can be displayed, facilitating a user's selection of a product. Moreover, additional information can be effectively provided to a user without the assistance of a sales clerk.

Second Embodiment

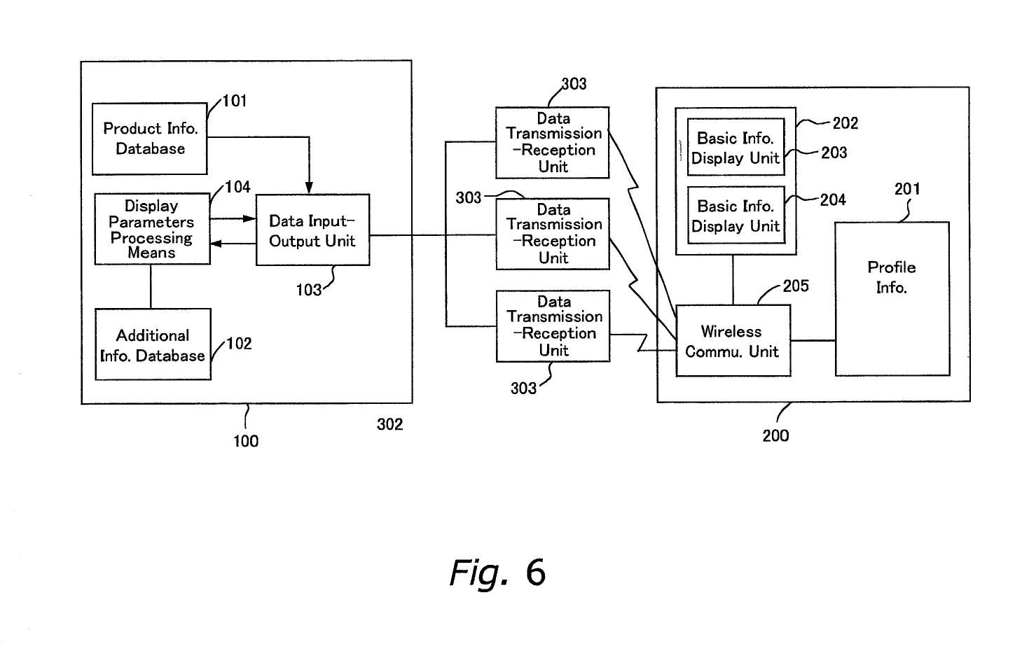

In another possible configuration, the product information display unit 300 in the first embodiment is eliminated, and in its place a product information display unit 202 is provided in the user terminal 200. The configuration of such a second embodiment is shown in FIG. 6.

As shown in FIG. 6, the product information management server 100 has roughly the same configuration as the product information management server 100 in the first embodiment. One point of variation from the first embodiment is that a data input-output unit 103 is interconnected with a data transmission/reception unit 303 provided near each product. The data transmission/reception unit 303 receives profile information transmitted from the user terminal 200 and transmits basic information and additional information for each product to the user terminal 200.

The user terminal 200 comprises a profile information storage unit 201 that is various types of memory and a wireless transmission-reception unit 205 capable of exchanging data with the data transmission/reception unit 303 of the product information management server 100.

The product information display unit 202 of the user terminal 200 comprises a basic information display unit 203 and an additional information display unit 204. The product information display unit 202 may be a liquid crystal display device, an LED or the like; the display screen of a single display device may be divided into the basic information display unit 203 and the additional information display unit 204, a separate display device may be used for each, or a single display device may be made to comprise both the basic information display unit 203 and the additional information display unit 204 by alternating between the two.

As with the first embodiment, in the second embodiment, user profile information sent from the wireless communication unit 205 of the user terminal 200 is received by the data transmission/reception unit 303. The profile information received by the data transmission/reception unit 303 is input into the display parameters processing means 104 via the data input-output unit 103 along with the product identification corresponding to the received data transmission/reception unit 303.

The display parameters processing means 104 transmits to the user terminal 200 via the data input-output unit 103 and the data transmission/reception unit 303 additional information selected according to product basic information corresponding to the transmitted and inputted profile information product identification.

At the user terminal 200 the transmitted product information is handled thusly: basic information is displayed at the basic information display unit 203 of the product information display unit 202 and additional information is displayed at the additional information display unit 204.

Thus a user, by checking the product information display unit 202 of the user terminal at hand, can easily check the basic information and the additional information of a product, facilitating the selection of a product to purchase. Further, when differing additional information is displayed depending upon user profile information, it is possible to have certain additional information presented only to certain users. For example, if discount rates are set differently from user to user, the system may be configured so that only the user for whom a certain discount is informed of his or her discount rate, without other users learning of this rate.

The system may also be configured so that the basic information display unit 203 is not included in the user terminal 200, but is provided near the products, along with the data transmission/reception unit 303.

Third Embodiment

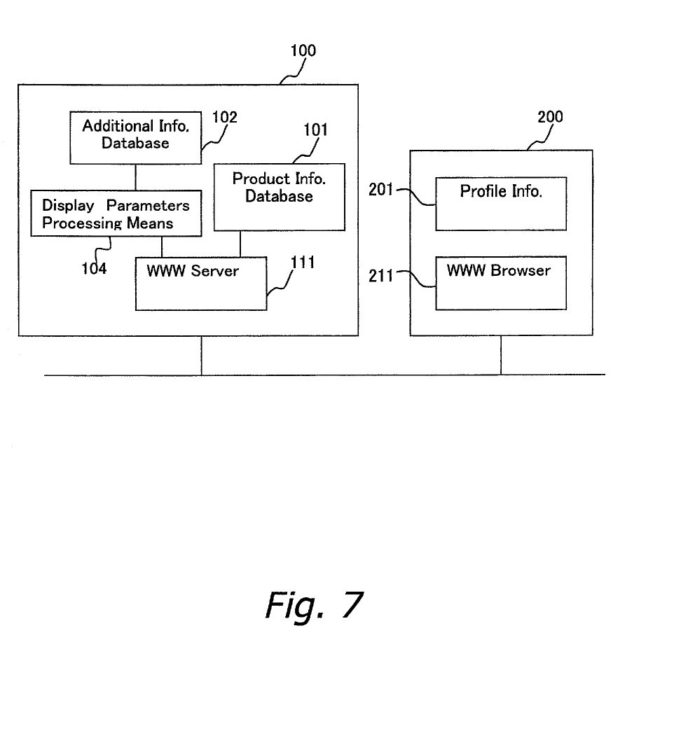

A third embodiment of the present invention will be explained while referring to the block diagram of FIG. 7.

This third embodiment illustrates an example of online shopping, where the product information management server 100 and the user terminal 200 are interconnected over a network.

The product information management server 100 manages the product information database 101 and the additional information database 102; it comprises the display parameters processing means 104, which selects from the additional information database 102 additional information corresponding to user profile information, and a WWW server 111 for presenting the user terminal 200 with various types of information.

This WWW server 111 is configured so that when there has been a request for information over a network using HTTP protocol, it presents the requested information to the user terminal 200 that made the request. The WWW server 111 also transmits page data (e.g., documents composed in HTML format) comprising basic product information in the product information database 101 according to requests from the user terminal 200, and it has the function of embedding additional information in this page data. The embedding of additional information can be realized through CGI (Common Gateway Interface) or other means.

Display parameters processing means 104 compares the profile information received from the user terminal 200 against the additional information database 102 and depending upon the results of the comparison selects the optimal additional information. As with the first embodiment, the system may be configured so that sex, age, occupation and other parameters for determining users to whom product recommendations will be made are registered beforehand for each product in the additional information database 102, and the decision of what additional information to transmit will depend upon a comparison with profile information.

The user terminal 200 may be a personal computer capable of connecting with the Internet; it comprises a profile database 201 that stores user profile information and a WWW browser 211 for viewing information presented by the WWW server 111.

When a user connects to the product information management server 100 from the user terminal 200 by using the WWW browser 211, the user inputs the address (URL) of the product information management server 100 into the WWW browser 211 to access the WWW server 111. At this time, following the address, the product information management server 100 is notified of the user profile information stored in the profile information storage unit 201.

The product information management server 100 acquires information from the product information database 101, where the product information requested by the user is stored, and provides the display parameters processing means 104 with user profile information.

The display parameters processing means 104 compares the user profile information with the additional information database 102 and extracts additional information for each product in accordance with the profile information. The system is configured so that the extracted additional information is embedded in the product page data by the WWW server 111, and when it is displayed on the WWW browser 211 of the user terminal 200, it is represented by an icon and the like so that it is visually distinguishable.

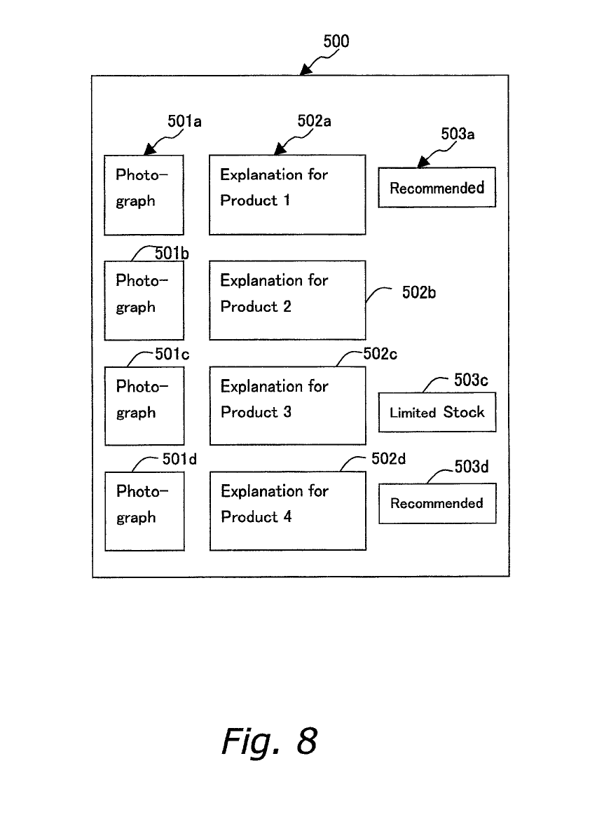

FIG. 8 shows an example of the configuration of a screen displayed on the WWW browser 211 of the user terminal 200.

In this embodiment, on the product information screen 500 displaying product information, photo information for each product is displayed in a photograph display unit 501a, a photograph display unit 501b etc., and to the right thereof explanations for each product are displayed in a product explanation unit 502a, product explanation unit 502b, etc. The information displayed in the photograph display units 501 and the product explanation units 502 is basic information extracted from the product information database 101.

On the right-hand edge of the product information screen 500 additional information display units 503a to 503d are provided. These additional information display units 503 display product additional information sent from the product information management server 100 that corresponds to the profile information of the viewing user; as described above, they can be displayed as icons, to make them visually distinguishable. In the example shown in FIG. 8, the additional information display units 503a and 503d are displaying “recommended,” while the additional information display unit 503c displays “limited stock.”

The displays of the additional information display units 503 will be different depending upon the user profile information, and when there are changes in profile information the displays are accordingly updated. Therefore, when a change in profile information has been input from the user terminal 200, additional information corresponding thereto is transmitted from the product information management server 100, and the additional information displayed on the WWW browser 211 is updated.

In addition, when there has been a change in the additional information database 102, the additional information displayed on the WWW browser 211 is accordingly updated. The manager of an online shopping site, by referring to the profile information of a user that has actually made a purchase and modifying the additional information database 102, can, without updating the product information database 101, update valuable information, such as recommendation information, that will assist a user in selecting products to purchase.

Fourth Embodiment

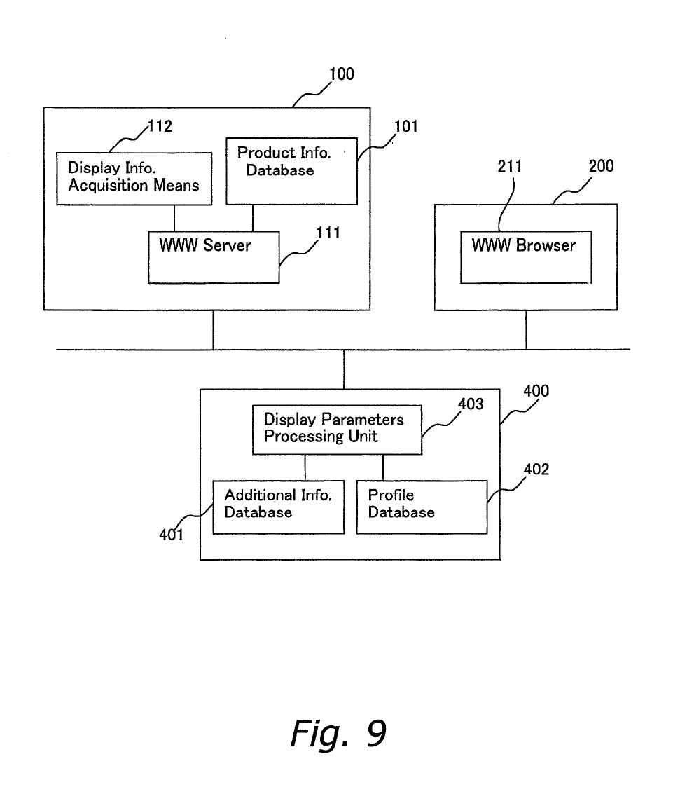

FIG. 9 shows the configuration of a fourth embodiment of the present invention.

In this fourth embodiment, as with the third embodiment, the product information management server 100 and the user terminal 200 are interconnected over a network, and these are also interconnected with an additional information management server 400, which manages an additional information database 401 and a profile database 402.

The product information management server 100 comprises the product information database 101, the WWW server 111, and the display information acquisition unit 112. The product information database 101, as in the previous embodiments, stores basic information for each product. The WWW server 111, in accordance with requests from the user terminal 200, provides various types of information to user terminals; as with the third embodiment, it is configured to provide product basic information stored in the product information database 101, and to embed additional information corresponding to user profile information into the page data showing product basic information and to present this to the user. The display information acquisition unit 112 acquires user identification information sent from the user terminal 200, transmits this user identification information to the additional information management server 400, and acquires display information based on the additional information transmitted from the additional information management server 400.

The user terminal 200 comprises the WWW browser 211 and allows for the viewing of various types of information provided by the WWW server 111.

The additional information management server 400 manages the additional information database 401 and the profile database 402, and includes a display parameters processing unit 403 that selects additional information according to user profile information. The display parameters processing unit 403 searches the profile information in the profile database 402 based on user identification information transmitted from the product information management server 100 and acquires the relevant user profile information. The display parameters processing unit 403 further selects from the additional information database 401 additional information corresponding to this profile information, which it sends to the display information acquisition unit 112 of the product information management server 100.

In this fourth embodiment, determination of the appropriate additional information is not performed by the product information management server 100, but rather such determination of additional information is made by the additional information management server 400 that manages the additional information database 401 and the profile database 402. Therefore, when there has been a request for product information from the user terminal 200, using the display information acquisition unit 112, the product information management server 100 makes an inquiry to the display parameters processing unit 403 of the additional information management server 400.

In this embodiment, it is presumed that a user has registered his or her own profile information at the additional information management server 400. However, the system may be configured so that when an unregistered user makes access, the WWW server 111 of the product information management server 100 uses CGI or similar function to prompt the user to register at the additional information management server 400.

When a user accesses the product information management server 100 from the user terminal 200, the user inputs the address (URL) of the WWW server 111 into the WWW browser 211. At this time user identification information such as user name and user ID is transmitted to the product information management server 100 from the user terminal 200.

The product information management server 100 acquires from the product information database 101 product basic information for which there has been a request from the user terminal 200, and it transmits to the additional information management server 400 via the display information acquisition unit 112 user identification information and identification for the product that the user wishes to look up.

The display parameters processing unit 403 of the additional information management server 400 acquires from the profile database 402 user profile information corresponding to the user identification information received from the product information management server 100; based on the product identification information it acquires the corresponding additional information from the additional information database 401; it then compares the two to determine the additional information to be displayed. The display parameters processing unit 403 transmits to the display information acquisition unit 112 of the product information management server 100 the additional information thus determined.

The product information management server 100 presents to the requesting user terminal 200 product information into which the WWW server 111 has embedded the additional information that the display information acquisition unit 112 has received.

With such a configuration, because user profile information is managed by a computer other than the product information management server 100 and the user terminal 200, personal information is not relayed directly to a store; therefore, a user can have peace of mind when using this system. If the system is configured so that such information as the address to which a product is to be sent and credit card number for settlement is managed as user profile information and a separate organization that manages this server takes care of product delivery, information that can identify a user will not be divulged to stores, thus preventing stores from sending direct mailings, sales and the like.

Moreover, because a store has to manage only the product information database 101 within the product information management server 100, it will not have to worry about such complicated tasks as updating the additional information database, setting additional information parameters, setting the screen for displaying additional information, leaving all these to the additional information management server 400.

Fifth Embodiment

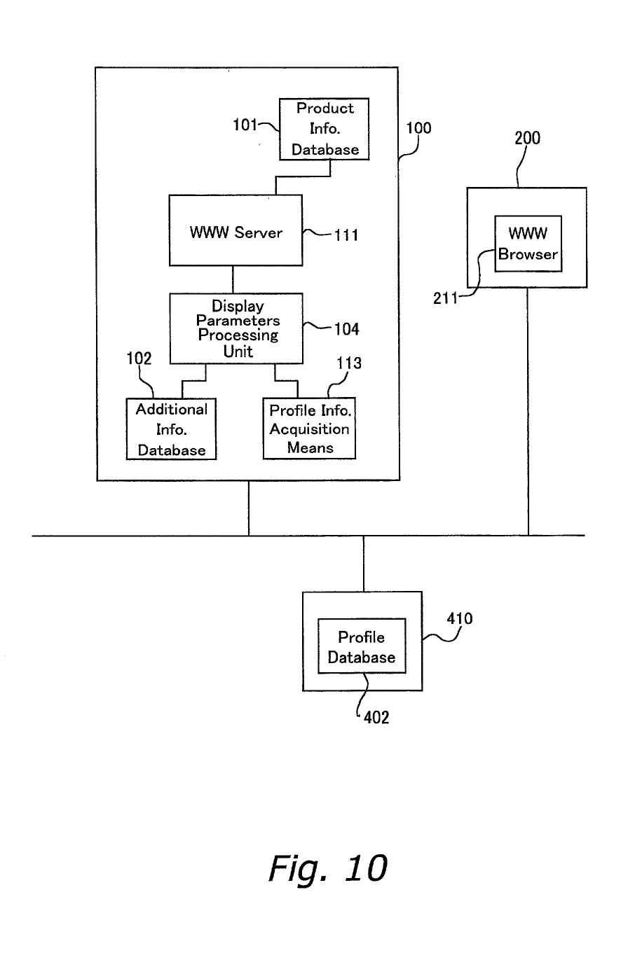

FIG. 10 shows the configuration of a fifth embodiment of the present invention.

This fifth embodiment is configured so that the additional information database 102 and the display parameters processing means 104 are provided on the product information management server 100, as with the third embodiment, and to comprise a customer management server 410 to manage the profile database 402 in place of the additional information management server 400.

The product information management server 100 is further provided with a profile information acquisition unit 113. This profile information acquisition unit 113 is configured to transmit to the additional information management server 400 the user identification information transmitted from the user terminal 200, receive from the additional information management server 400 profile information corresponding to this user identification information, and provide this to the display parameters processing means 104.

As with the fourth embodiment, with this fifth embodiment, a user only has to transmit via the WWW browser 211 such identification information as user name and user ID in order to obtain product basic information managed by the product information management server 100 and additional information in accordance with user profile information, facilitating product selection. Profile information is managed by a computer other than the product information management server 100, meaning that there is no need to worry about the user's personal information being divulged to the managers of online shopping stores and allowing the user to use this system with peace of mind.

Sixth Embodiment

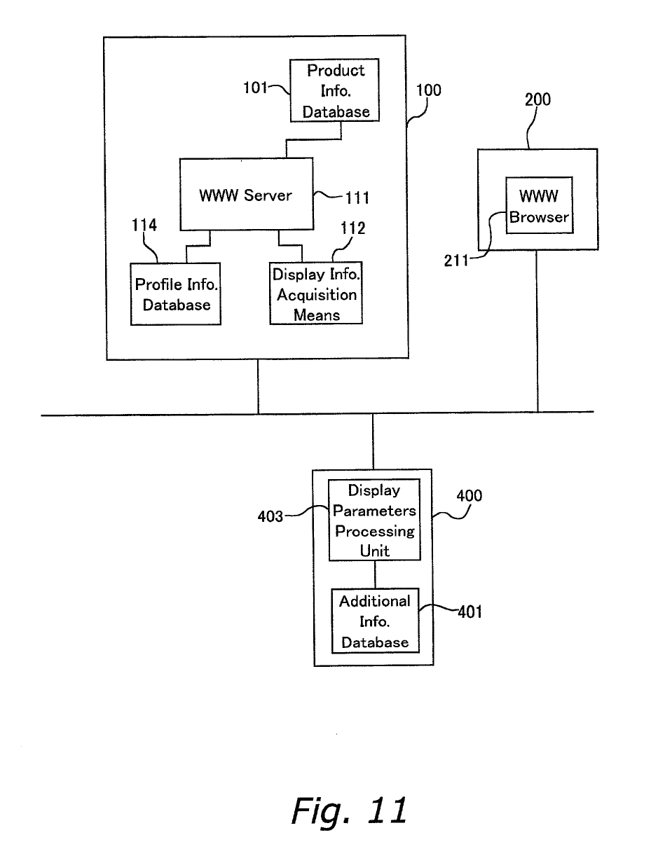

FIG. 11 shows the configuration of a sixth embodiment of the present invention.

In this sixth embodiment, the product information management server 100 manages the product information database 101 and a profile database 114, and the additional information management server 400, which is interconnected with the product information management server 100 over a network, manages the additional information database 401.

The display information acquisition unit 112 is provided in the product information management server 100. This display information acquisition unit 112 searches the profile database 114 based on the user identification information transmitted from the user terminal 200, transmits the corresponding profile information to the additional information management server 400 and acquires display information using the additional information transmitted from the additional information management server 400.

The display parameters processing unit 403 is provided in the additional information management server 400; based on profile information transmitted from the product information management server 100, it selects the corresponding additional information from the additional information database 401 and transmits this to the display information acquisition unit 112 of the product information management server 100.

As with the fourth and fifth embodiments, in this sixth embodiment, a user only has to transmit such identification information as user name and user ID via the WWW browser 211 in order to obtain product basic information managed by the product information management server 100 and additional information in accordance with user profile information, facilitating product selection.

For the manager of the product information management server 100, because there is no need to maintain the additional information database 401, complicated tasks can be eliminated.

Seventh Embodiment

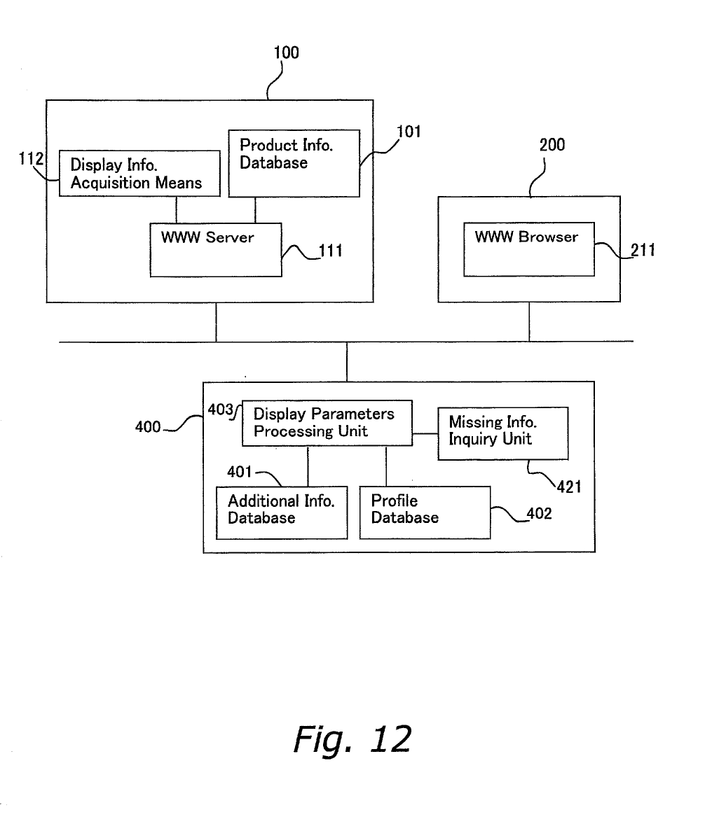

The system can be configured so that, when additional information is selected from the additional information database based on user profile information stored in the profile database, if the parameters for selection have not been registered in the profile information, a request is directed to the user terminal for input of the parameters that have not been registered. FIG. 12 shows such a configuration applied to a system similar to the fourth embodiment, wherein the additional information management server 400 manages the additional information database 401 and the profile database 402.

This seventh embodiment has the configuration shown in FIG. 9, with the addition of a missing information inquiry unit 421 provided in the additional information management server 400.

In this seventh embodiment, the display parameters processing unit 403 of the additional information management server 400 uses user identification information received from the product information management server 100 to search the profile database 402 for the corresponding profile information. The display parameters processing unit 403 also uses product identification information received from the product information management server 100 to search the additional information database 401 for additional information. If, when the additional information and profile information extracted from the respective databases are compared, there is information in the profile information that has not been registered, then the missing information inquiry unit 421 gives notification to this effect.

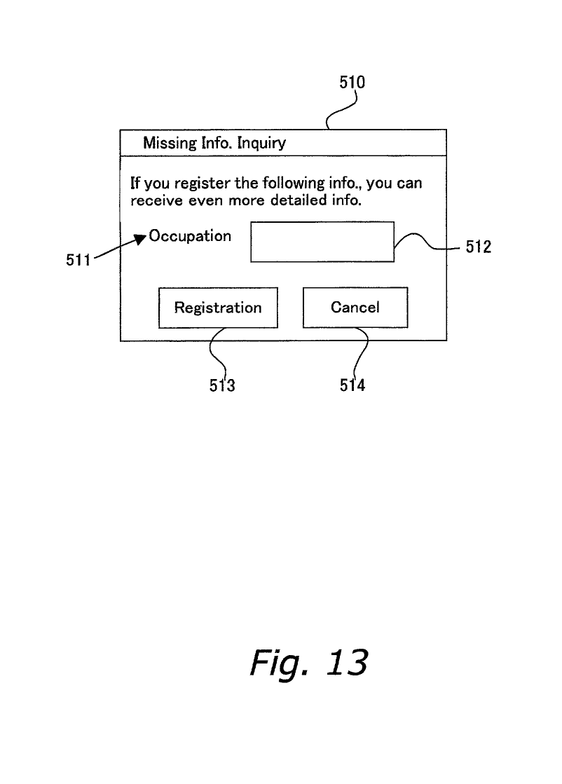

The notification from the missing information inquiry unit 421 is configured so that it is transmitted to the product information management server 100 and displayed on the WWW browser 211 of the user terminal 200 via the WWW server 111. For example, when additional information for a product a user wishes to look up is displayed according to the data for occupation within the user profile information, if data for occupation is not registered within a user's profile information, a missing information inquiry screen 510 as shown in FIG. 13 can be displayed on the WWW browser 211. This missing information inquiry screen 510 comprises a missing information notification unit 511 for showing what information is missing, an information input unit 512 for input of the missing information by the user, a registration button 513 for transmitting the input information, a cancel button 514 for canceling the input information, and the like.

When a user has inputted information using the missing information inquiry screen 510 displayed at the user terminal 200, the inputted information is transmitted to the display parameters processing unit 403 of the additional information management server 400. The display parameters processing unit 403 updates the information within the profile database 402, selects additional information within the additional information database 401 based on the new profile information, and transmits the additional information to the display information acquisition unit 112. This additional information is displayed on the WWW browser 211 of the user terminal 200 via the WWW server 111 of the product information management server 100.

When there are a number of items that have not been registered within the profile information, the user can be asked to fill in the missing data all at once, but it is preferable to ask the user to fill in the information one piece at a time or several pieces at a time, in temporally spaced sessions. This is because many users dislike being asked to supply a large amount of information at once, and there is the danger that the user will cut the connection when asked to fill in a lot of information. Therefore, when user profile information is first registered, the user is asked to fill in several items, and thereafter the missing pieces of information can be gradually filled in, so that the profile information can be completed. In addition, by using the display parameters registered in the additional information database 401, it is possible to control the information that stores want users to register as profile information.

Eighth Embodiment

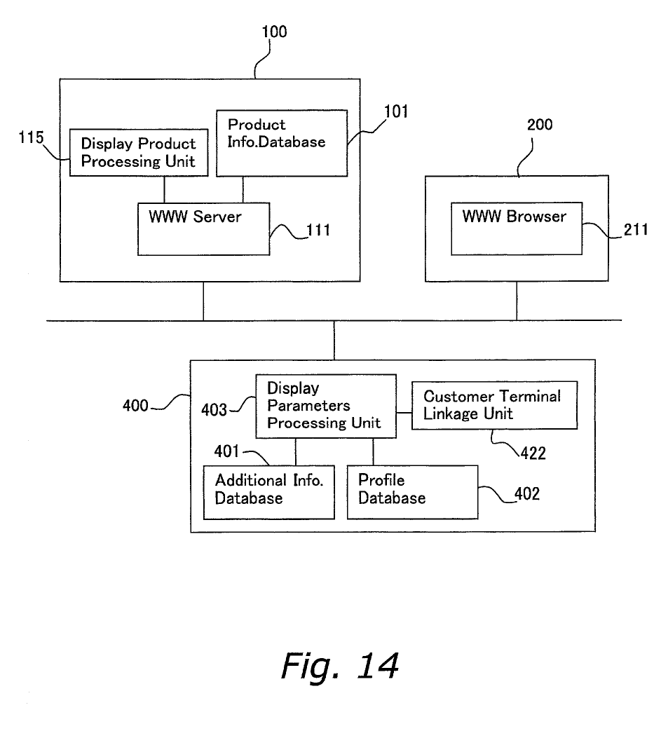

FIG. 14 shows the configuration of an eighth embodiment of the present invention.

The eighth embodiment has the same configuration as the fourth embodiment, as shown in FIG. 9, with the addition of a customer terminal linkage unit 422 within the additional information management server 400. This customer terminal linkage unit 422 is configured to communicate with the user terminal 200 and to operate in concert with the WWW browser 211 of the user terminal 200.

A display part processing unit 115 is provided in the product information management server 100. This display part processing unit 115 communicates with the customer terminal linkage unit 422 of the additional information management server 400 to directly acquire additional information from the user terminal 200 and creates a display part to display this additional information on the WWW browser 211. This display part is embedded by the WWW server 111 into the product information as a Java applet, ActiveX control or the like, and gives notification of this acquired information to the WWW browser 211 of the user terminal 200.

A user registers his or her own profile information beforehand in the profile database 402 in the additional information management server 400. When a user connects with the product information management server 100 from the user terminal 200 using the WWW browser 211, the user inputs the address (URL) of the WWW server 111 and requests product information. At the same time, the user terminal 200 transmits to the product information management server 100 such identification information as user name and user ID.

The WWW server 111 acquires product basic information from the product information database 101 which stores the requested product information, and through the display part processing unit 115 it causes the creation of an additional information display part to which user identification information and product identification information have been given. The WWW server 111 embeds in the product information acquired from the product information database 101 the additional information display part comprising the Java applet or the like created by the display part processing unit 115 and transmits it to the user terminal 200.

Transmitted product information is displayed on the WWW browser 211 of the user terminal 200. At the same time, the additional information display part communicates with the customer terminal linkage unit 422 of the additional information management server 400, and receiving from the additional information management server 400 the additional information that the display parameters processing unit 403 has selected based on the user identification information and product identification information given to the display part, it causes the display on the WWW browser 211 to change.

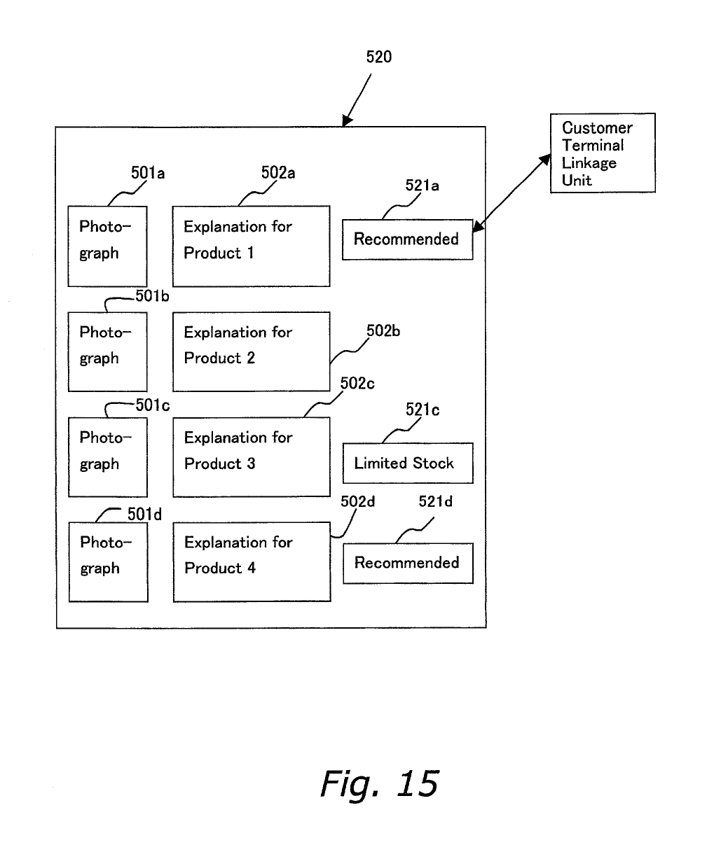

For example, as shown in FIG. 15, when a product information screen 520 has been configured on the WWW browser 211, photo information for each product is displayed in a photograph display unit 501a, photograph display unit 501b, etc., and to the right thereof explanations for each product are displayed in a product explanation unit 502a, product explanation unit 502b, etc. The information displayed in the photograph display units 501 and the product explanation units 502 is basic information extracted from the product information database 101, and is information that is transmitted from the WWW server 111.

On the right-hand edge of the product information screen 520 are display part embedded unit 521a through display part embedded unit 521d wherein additional information display parts have been embedded. These display part embedded unit 521a through display part embedded unit 521d communicate with the customer terminal linkage unit 422 of the additional information management server 400 and at the same time have programs operating in real time embedded therein. When a user changes a portion of his or her profile information or a store changes the parameters for product additional information, the result is immediately reflected in changes to the additional information.

With such a configuration, a user can make some changes to his or her own profile information and can easily obtain additional information under parameters different from his or her actual profile information and can get more information when selecting a product. Further, it becomes possible to display in real time the number of items in stock for a popular product and the like, and a user can refer to this when determining when to make a purchase.

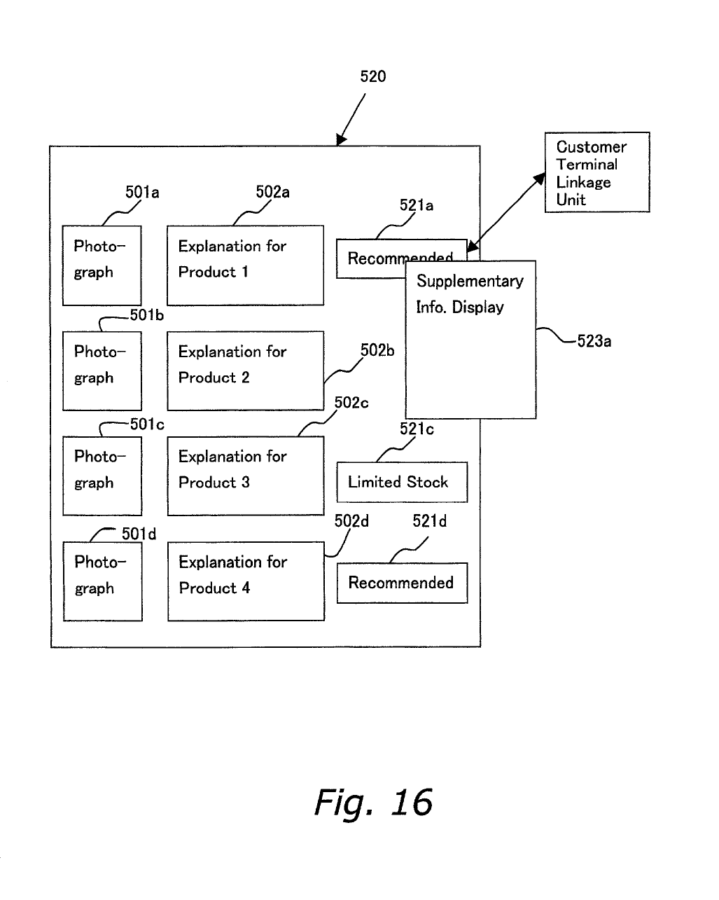

Further, the system may be configured so that comments regarding products are registered as product additional information, and when a cursor is placed above the display part embedded unit 521, additional information is displayed. For example, as shown in FIG. 16, when a cursor is placed above the display part embedded unit 521a, a new additional information window 523a appears, and additional information such as registered comments is displayed. In this way, additional information is not displayed until certain parameters are met, giving the layout of the screen for introducing products an uncluttered look, and making the product information on the WWW browser 211 easy to look at.

Ninth Embodiment

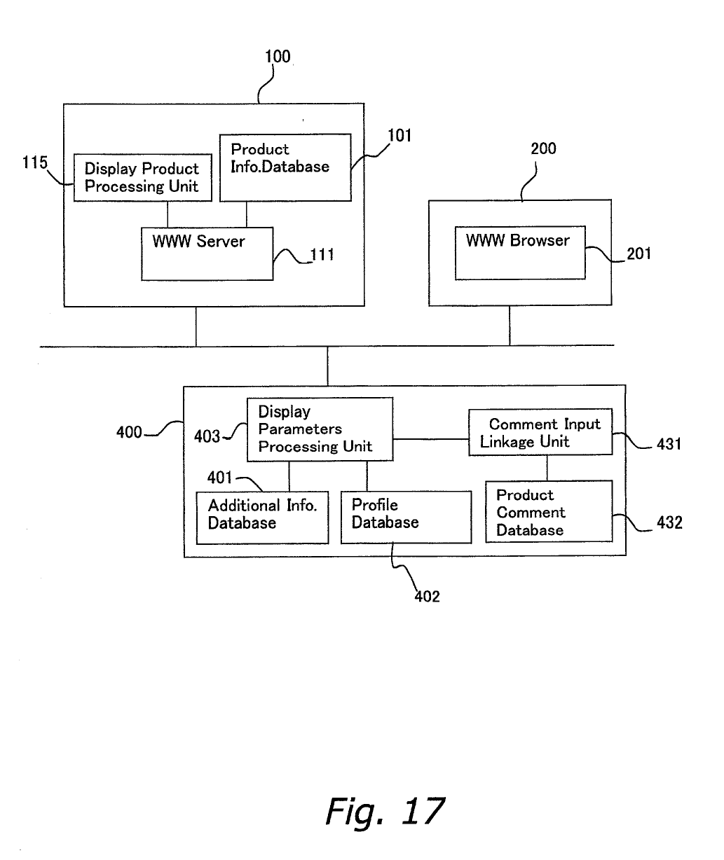

FIG. 17 shows the configuration of a ninth embodiment of the present invention.

This ninth embodiment has the configuration of the eighth embodiment, as shown in FIG. 14, except that in place of the customer terminal linkage unit 422 of the additional information management server 400, a comment input linkage unit 431 is provided. This comment input linkage unit 431 is configured to communicate with the user terminal 200 to display comment information on the WWW browser 211 of the 200 and accept the input of new comments from the WWW browser 211. The system is configured so that comment inputs that have been received are stored in a comment database 432 via the comment input linkage unit 431.

As in the eighth embodiment, a display part processing unit 115 is provided in the product information management server 100. This display part processing unit 115 creates a display part for communicating between the user terminal 200 and the comment input linkage unit 431 of the additional information management server 400 to display comment information on the WWW browser 211, and for receiving new comment information on the WWW browser 211. This display part is embedded by the WWW server 111 in the product information as a Java applet or ActiveX control, and is transmitted to the WWW browser 211 of the user terminal 200.

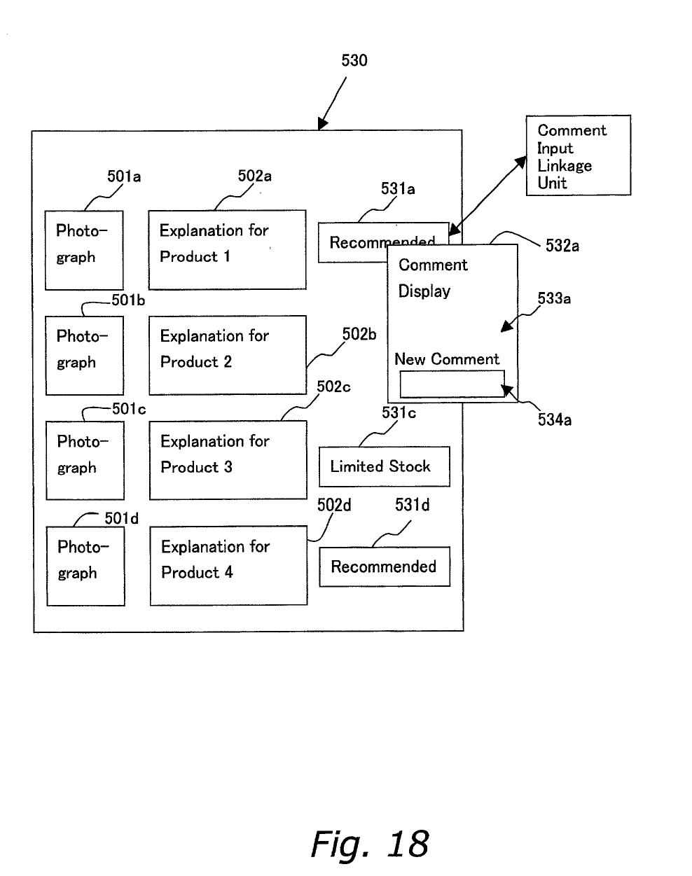

FIG. 18 shows an example of a product information screen on the WWW browser 211 of the user terminal 200. A product information screen 530 is provided with a photograph display unit 501a, photograph display unit 501b, etc., for displaying photo information for each product, and a product explanation unit 502a, product explanation unit 502b, etc. for displaying explanations for each product to the right thereof. The information displayed in the photograph display units 501 and the product explanation units 502 is basic information extracted from the product information database 101, and is information transmitted from the WWW server 111.

On the right-hand edge of the product information screen 530 are provided display part embedded units 531a through 531d wherein display parts for comment input linkage are embedded. These display part embedded units 531a through 531d communicate with the comment input linkage unit 431 of the additional information management server 400 and at the same time have programs that operate in real time.

When a user connects with the product information management server 100 by using the WWW browser 211 of the user terminal 200, the user inputs the address (URL) of the WWW server 111 and requests product information. At the same time, the user terminal 200 transmits user identification information such as user name and user ID to the product information management server 100.

The WWW server 111 acquires product basic information from the product information database 101, which stores the requested product information, and it acquires the display part for comment input linkage that the display part processing unit 115 has prepared. The WWW server 111 embeds the display part comprising a Java applet or the like prepared by the display part processing unit 115 into the product information acquired from the product information database 101 and transmits this to the user terminal 200.

The transmitted product information is displayed on the WWW browser 211 of the user terminal 200. At the same time, displayed on the display part embedded units 531a through 531d is an icon for a comment input applet that communicates with the comment input linkage unit 431 of the additional information management server 400. For example, when the display part embedded unit 531a is clicked on, a new comment display window 532a appears, comment information stored in the product comment database 432 is displayed in an element name missing 533a, and the input of comments into the new comment input unit 534a is accepted.

With this kind of configuration, it becomes possible for a user to select products while referring to comment information from users interested in the products, comments inputted by store clerks and the like; at the same time, by accepting comments from users, service to users can be improved.

For the product comment database 432, it is preferable that in such cases as when the amount of comment information does not increase when there is an independent database for each product, comment databases be shared by products belonging to the same category. Further, the system may be so configured that after a set period of time has elapsed information in the product comment database 432 is deleted, or so that only comments allowed by store clerks are disclosed.

Tenth Embodiment

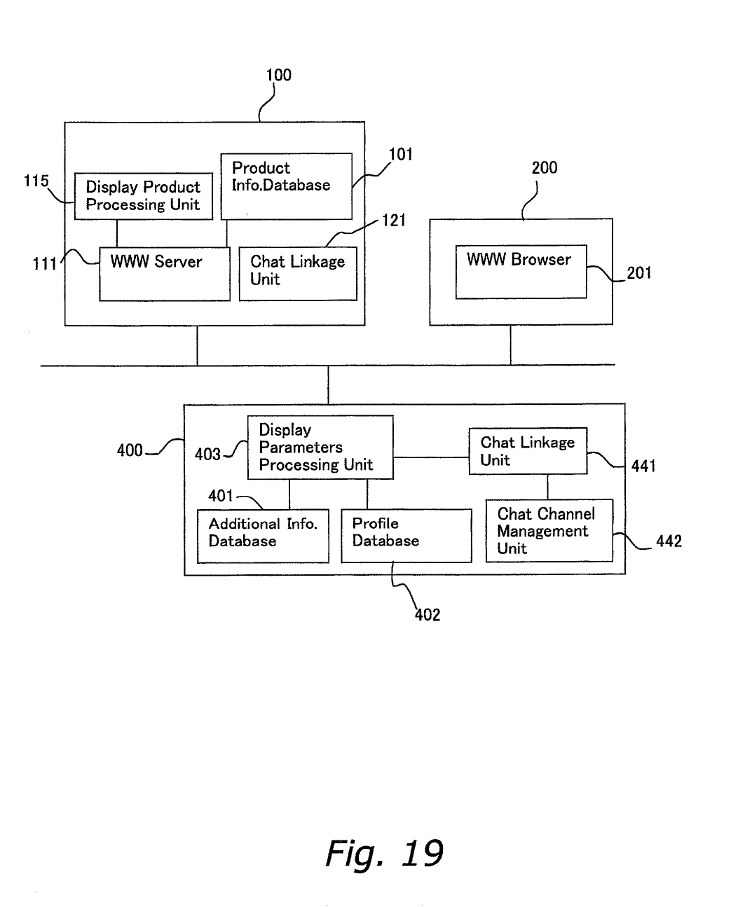

FIG. 19 shows the configuration of a tenth embodiment of the present invention.

This tenth embodiment has the same configuration as the eighth embodiment as shown in FIG. 14, with the exception that in place of the customer terminal linkage unit 422 of the additional information management server 400 a chat linkage unit 441 has been provided. This chat linkage unit 441 is configured to communicate with a user terminal 200 operating an applet for chat and to transmit and receive messages in real time. Messages sent between the chat linkage unit 441 and the user terminal 200 are stored by a chat channel management unit 442 as log information, with such information as sender, receiver, time sent, etc., attached to each message.

As in the eighth embodiment, a display part processing unit 115 is provided in the product information management server 100. This display part processing unit 115 creates a display part for communicating between the user terminal 200 and the chat linkage unit 441 of the additional information management server 400 and for sending and receiving messages. This display part is embedded by the WWW server 111 in the product information as a Java applet or ActiveX control, and is transmitted to the WWW browser 211 of the user terminal 200.

Further, a chat terminal unit 121 is provided in the product information management server 100, allowing for the transmission of messages to and from the chat linkage unit 441 of the additional information management server 400.

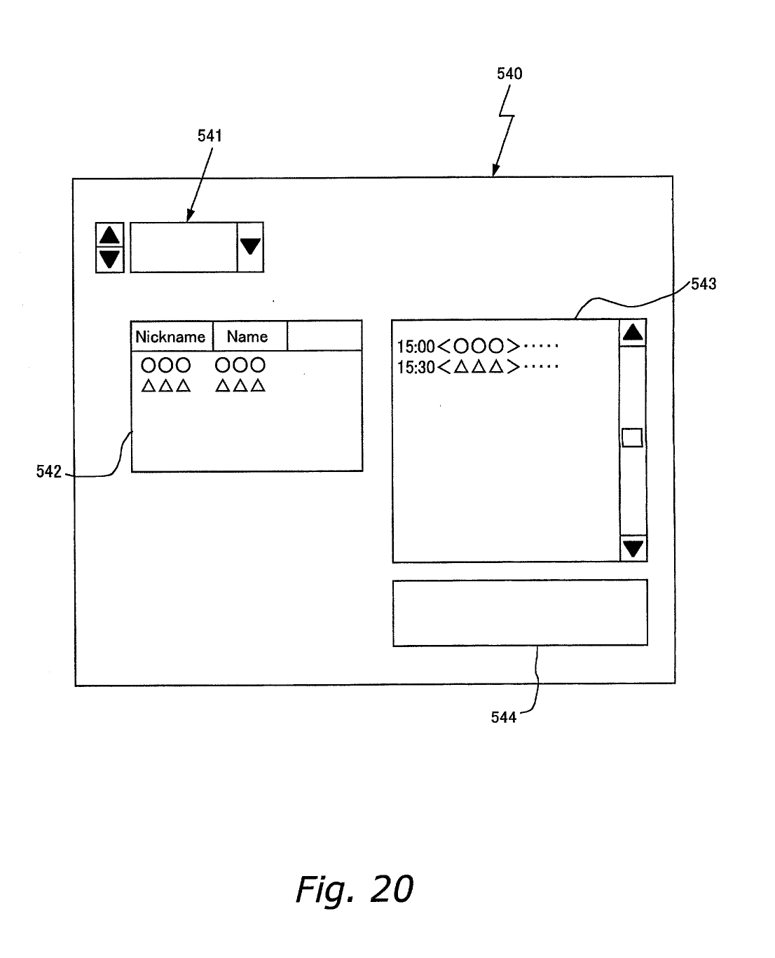

When the product information screen is displayed on the WWW browser 211 of the user terminal 200, a display part for chat linkage is displayed by an icon or the like. When this display part on the product information screen is clicked on, an applet for transmitting messages to and from the chat linkage unit 441 is activated, and a chat window is displayed on the screen. FIG. 20 shows one example of a chat window.

A chat window 540 comprises a chat selection unit 541, a channel participant display unit 542, a chat log display unit 543, a message input unit 544 and the like. The system is configured so that a chat channel is set for each product category, and by selecting a chat channel from a pop-up menu of the chat selection unit 541, a user can move to different channels. In the channel participant display unit 542, the nicknames and names and the like of users, shop clerks and others participating in the channel are displayed. Users and shop clerks displayed in the channel participant display unit 542 can send and receive messages in real time.

At the user terminal 200, by inputting a message in the message input unit 544 of the chat window 540, a user can send messages to channel participants. Messages sent from the user terminal 200 are stored in the chat channel management unit 442, and are sent by the chat linkage unit 441 to the WWW browsers of terminals of other users who are chat participants and to the chat terminal unit 121 of the product information management server 100. Attached to messages thus sent is such information as time transmitted and transmitter, which is displayed in the chat log display unit 543. The system may be configured so that if the chat log in real time is scattered, the chat log under management by the chat channel management unit 442 can go back and be referred. Channels may be configured according to product units and category units, and channels may be made based upon common points shared by users.

With such a configuration, chats can be conducted between users and store clerks or between users and users via the chat linkage unit 441, allowing for the exchange of information regarding products. Further, by connecting simultaneously to all of the channels that a store is involved in at the chat terminal unit 121 of the product information management server 100, a store can respond to questions from users.

Eleventh Embodiment

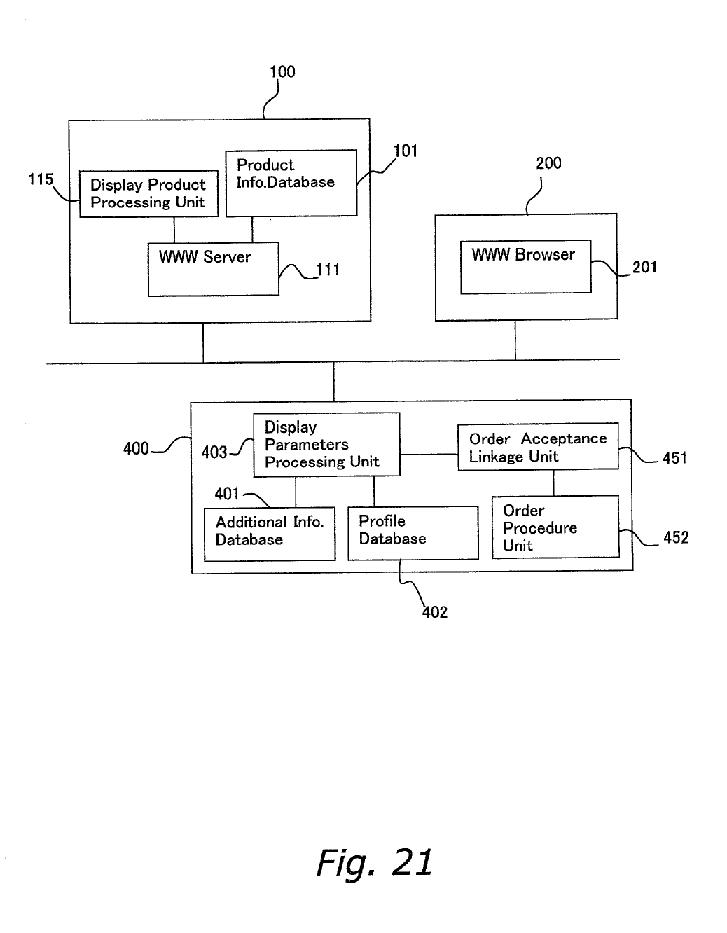

FIG. 21 shows an eleventh embodiment of the present invention.

This eleventh embodiment has the same configuration as the eighth embodiment as shown in FIG. 14, with the exception that in place of the customer terminal linkage unit 422 of the additional information management server 400 there is an order acceptance linkage unit 451. This order acceptance linkage unit 451 links with the WWW browser 211 of the user terminal 200 and accepts order information. Order information received by the order acceptance linkage unit 451 is forwarded to the order procedure unit 452. The order procedure unit 452, based on the order information accepted by the order acceptance linkage unit 451, acquires from the profile database 402 information necessary for payment, such as user address and credit card number and then issues an order ticket.

A display part processing unit 115 similar to the one in the eighth embodiment is provided in the product information management server 100. This display part processing unit 115 creates a display part for communicating from the user terminal 200 to the order acceptance linkage unit 451 of the additional information management server 400 and for accepting order information. This display part is embedded by the WWW server 111 as a Java applet or ActiveX control in the product information, and is transmitted to the WWW browser 211 of the user terminal 200.

When a product information screen is displayed on the WWW browser 211 of the user terminal 200, a display part for order acceptance linkage is simultaneously displayed as an icon or the like. When this display part on the product information screen is clicked on, an applet for linkage with the order acceptance linkage unit 451 is activated, and a window for order information input appears on the screen. By inputting predetermined items in this order information input window, a user can send order information.

With this kind of configuration, a user can make purchases with peace of mind, as the user's personal information will not be relayed to stores. Further, because the store can recognize information relating to the relation between profile information and ordered products, it is possible to obtain detailed market information, which will help with product development.

Other Embodiments

(A) The functions of the following may all be provided together within the additional information management server 400: the missing information inquiry unit 421 of the seventh embodiment, the customer terminal linkage unit 422 of the eighth embodiment, the comment input linkage unit 431 of the ninth embodiment, the chat linkage unit 441 of the tenth embodiment, the order acceptance linkage unit 451 of the eleventh embodiment, etc. In such a configuration, the product information screen transmitted from the product information management server 100 to the WWW browser 211 of the user terminal 200 will have Java applets or ActiveX controls allowing for linkage with the respective linkage units embedded therein, which will be displayed as icons or the like.

(B) The system may be configured so that the functions of the following are provided within the product information management server 100 of the third embodiment: the missing information inquiry unit 421 of the seventh embodiment, the customer terminal linkage unit 422 of the eighth embodiment, the comment input linkage unit 431 of the ninth embodiment, the chat linkage unit 441 of the tenth embodiment, the order acceptance linkage unit 451 of the eleventh embodiment, etc.

The present invention presents additional information appropriate for each individual user based on that user's profile information, and allows a store to make an effect presentation to individual users. Also, because a user can look up additional information that is in accordance with his or her own profile information, that user can easily obtain clues to assist with product selection.

In particular, in such applications as online shopping over the Internet, specialized knowledge is needed to create web pages on the World Wide Web, making it difficult for a store to provide additional information for each individual product, but because product information and additional information are managed separately, it becomes easy to provide additional information even without special skills. Also, because the user profile is looked up when a user has requested a WWW page relating to a product, it is possible to select the additional information to be displayed, and to change the additional information to be displayed depending on the user. In this way, even with online shopping that is in operations 24 hours a day, it becomes possible to automatically attend to customers in a manner similar to face-to-face service, without actually having sales personnel on duty.

This system makes database maintenance easy for a store, as information that is updated infrequently, such as information explaining a product, and information that needs to be updated daily, such as the amount of stock for a popular product or the types of customers that have made certain purchases, are managed separately. Also, linkage with a POS terminal is conceivable, so that for information that needs to be updated daily, the troublesome work involved in acquiring information can be eliminated, and users can be provided with new and accurate information. Furthermore, if a different organization manages user profile information, it becomes easy to obtain personal information from users, and by having the organization provide notification to stores of information other than address, credit card number and the like, detailed market information becomes available to stores.

Furthermore, if a separate organization manages additional information and profile information, a user can purchase products without having to inform a store of information that he or she wishes to keep confidential, such as address and credit card number, that can be used to identify a user, meaning that the user can have peace of mind when registering personal information and making it easier for a user to use this system. If the number of users registering their profile information in this way grows large, it will be possible to analyze marketing information from the relationship between product and profile information, and the organization managing the profile information and additional information will be able to provide appropriate support to stores.

While only selected embodiments have been chosen to illustrate the present invention, to those skilled in the art it will be apparent from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

What is claimed is:

1. A product information notification method wherein:
acquiring profile information of a user wishing to look up basic information for an individual product;
selecting and presenting to said user basic information of a product group that said user wishes to look up from a product information database storing basic information of said individual product; and
selecting and presenting to said user additional information regarding products in said product group that corresponds to said user profile information from a database storing additional information for said individual product.

2. A product information notification system comprising:
profile information acquisition means for acquiring profile information of a user wishing to look up basic information for an individual product;
a product information database storing basic information for said individual product;
product information presentation means for presenting from said product information database basic information of a product group that said user wishes to look up;
an additional information database storing additional information for said individual products;
display parameters processing means for selecting corresponding additional information from said additional information database based on profile information acquired by said profile information acquisition means; and
additional information presentation means for presenting to said user additional information selected by said display parameters processing means.

3. The product information notification system according to claim 2, wherein said profile information acquisition means conducts wireless communication with a user terminal storing that user's profile information to acquire said user's profile information.

4. The product information notification system according to claim 2, wherein said profile information acquisition means conducts wireless communication with a user terminal storing that user's identification information, and acquires from a profile database storing user profile information user profile information corresponding to said user identification information.

5. A product information notification system according to claim 2, wherein said product information presentation means and additional information presentation means include, respectively, product information presentation means and additional information presentation means provided in the vicinity of said individual product.

6. A product information notification system according to claim 3, wherein said product information presentation means and additional information presentation means respectively include product information transmission means transmitting information to be displayed by product information display means and additional information display means provided on said user terminal.

7. The product information notification system according to claim 2, having a product information management server comprising a WWW server that manages said product information database and presents information to a user terminal having a WWW browser, said WWW server comprising said product information presentation means and additional information presentation means.

8. The product information notification system according to claim 7, wherein said profile information acquisition means acquires a user's profile information from said user's terminal over the Internet.

9. The product information notification system according to claim 7, wherein said profile information acquisition means acquires a user's identification information from said user's terminal over the Internet, and acquires from a profile database storing user profile information profile information corresponding to said user's identification information.

10. The product information notification system according to claim 9, wherein said product information management server manages said profile database.

11. The product information notification system according to claim 9, wherein a customer management server interconnected with said product information server manages said profile database.

12. A product information notification system according to claim 7, wherein said product information server manages said additional information database and includes said display parameters processing means.

13. The product information notification system according to claim 7, wherein an additional information management server interconnected with said product management server manages said additional information database and includes said display parameters processing means.

14. The product information notification system according to claim 7, wherein said product information presentation means and additional information presentation means include a terminal linkage unit that operates on a WWW browser on said user terminal.

15. The product information notification system according to claim 14, wherein said terminal linkage unit is a Java applet for displaying additional information.

16. The product information notification system according to claim 14, wherein said terminal linkage unit is a Java applet for comment input accepting input of comments from said user terminal.

17. The product information notification system according to claim 16, further comprising a comment database managing comments from said user terminal accepted by said terminal linkage unit.

18. The product information notification system according to claim 14, wherein said terminal linkage unit is a chat linkage unit accepting chat by said user terminal.

19. The product information notification system according to claim 18, further comprising a chat channel management unit managing chat contents accepted by said chat linkage unit.

20. The product information notification system according to claim 14, wherein said terminal linkage unit is an order acceptance linkage unit accepting product orders from said user terminal.

21. The product information notification system according to claim 20, further comprising an order procedure unit conducting order procedures based on a product order accepted by said order acceptance unit.

22. A computer readable recording medium on which is recorded a program for a product information notification method wherein:
acquiring profile information of a user wishing to look up basic information for an individual product;
selecting and presenting to said user basic information of a product group that said user wishes to look up from a product information database storing basic information of said individual product; and
selecting and presenting to said user additional information regarding products in said product group that corresponds to said user profile information from a database storing additional information for said individual product.
